(19) United States
(12) Patent Application Publication
(10) Pub. No.: US 2011/0208753 A1
(43) Pub. Date: Aug. 25, 2011

(54) Method and Apparatus for Computing Relevancy

(75) Inventor: Sunil Sivadas, Tampere (FI)

(73) Assignee: Nokia Corporation

(21) Appl. No.: 12/710,576

(22) Filed: Feb. 23, 2010

(51) Int. Cl. G06F 17/30; G06F 3/048

(52) U.S. Cl. 707/749; 715/764; 707/E17.015

(57) ABSTRACT

Various methods for computing relevancy are provided. One example method includes determining a behavior relevance factor for a user interface item, determining a semantic relevance factor for the user interface item, and determining an internal state of a user relevance factor for the user interface item. The example method further includes generating an overall relevance value for the user interface item. The overall relevance value may be a function of the behavior relevance factor, the semantic relevance factor, and the internal state of the user relevance factor. Similar and related example methods and example apparatuses are also provided.

### TECHNICAL FIELD

Embodiments of the present invention relate generally to information management, and, more particularly, relate to a method and apparatus for computing the relevancy of information to a user's context.

### BACKGROUND

In the information age, more and more data has become accessible to computing devices via advances in both storage memory and communications capabilities. Many users of computing devices have become dependent on the ability to access, apply, and forward this information quickly to assist in business and personal tasks. However, as the volume of available data increases, it can become cumbersome and unwieldy to identify data that is desirable to the user.

Search engines and data filters have attempted to fill this need, but many times searches and filters return too many possible matches (e.g., several thousand web sites) based on a given set of search terms or filter criteria. As such, continued sorting through the returned results via an unwieldy user interface may be required. Often times, the accuracy of the search or filtering operation may be inherently limited by the general use of term or word based criteria provided by the user to identify data. Further, even when a manageable amount of data is identified, how the user desires to interact with the data may be unknown to the computing device, requiring additional user interaction via the user interface on a conscious level.

### BRIEF SUMMARY

Example methods and example apparatuses are described herein that provide for computing relevancy of, for example, a user interface item. In this regard, items displayed in a user interface, also referenced as user interface items, such as emails, text messages, web pages, contacts, application icons, widgets, and the like, may be arranged or placed in the user interface based on a relevancy value. The relevance value may be a function, for example a nonlinear function, of a number of factors. Those factors may include a behavior relevance factor, a semantic relevance factor, and an internal state of the user relevance factor. The behavior relevance factor may be determined, for example by an electronic device, based on the actions or indications of action of a user captured by the electronic device. The semantic relevance factor may be determined based on data stored in a user's electronic device. The internal state of the user relevance factor may be determined based on physiological information captured by an electronic device.

Various example methods and apparatuses of the present invention are described herein, including example methods that involve computing relevancy. One example method includes determining a behavior relevance factor for a user interface item, determining a semantic relevance factor for the user interface item, and determining an internal state of a user relevance factor for the user interface item. The example method further includes generating an overall relevance value for the user interface item. The overall relevance value may be a function of the behavior relevance factor, the semantic relevance factor, and the internal state of the user relevance factor.

An additional example embodiment is an apparatus configured for computing relevancy. The example apparatus comprises at least one processor and at least one memory including computer program code, the at least one memory and the computer program code configured to, with the at least one processor, direct the apparatus to perform various functionality. The example apparatus may be directed to perform determining a behavior relevance factor for a user interface item, determining a semantic relevance factor for the user interface item, and determining an internal state of a user relevance factor for the user interface item. The example apparatus may also be directed to perform generating an overall relevance value for the user interface item. The overall relevance value may be a function of the behavior relevance factor, the semantic relevance factor, and the internal state of the user relevance factor.

Another example embodiment is a computer program product comprising a computer-readable storage medium having computer program code stored thereon, wherein execution of the computer program code causes an apparatus to perform various functionalities. Execution of the computer program code may cause an apparatus to perform determining a behavior relevance factor for a user interface item, determining a semantic relevance factor for the user interface item, and determining an internal state of a user relevance factor for the user interface item. Execution of the computer program code may also cause the apparatus to perform generating an overall relevance value for the user interface item. The overall relevance value may be a function of the behavior relevance factor, the semantic relevance factor, and the internal state of the user relevance factor.

Another example apparatus includes means for determining a behavior relevance factor for a user interface item, means for determining a semantic relevance factor for the user interface item, and means for determining an internal state of a user relevance factor for the user interface item. The example apparatus further includes means for generating an overall relevance value for the user interface item. The overall relevance value may be a function of the behavior relevance factor, the semantic relevance factor, and the internal state of the user relevance factor.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a schematic representation of a system configured for computing relevancy according to an example embodiment of the present invention;

FIG. 2 illustrates a flowchart for determining a semantic relevancy factor according to an example embodiment of the present invention;

FIG. 3 illustrates a flowchart for determining an internal state of a user relevancy factor according to an example embodiment of the present invention;

FIG. 4 illustrates a block diagram of an apparatus and associated system for computing relevancy according to an example embodiment of the present invention;

FIG. 5 illustrates a block diagram of a mobile terminal configured to compute relevancy according to an example embodiment of the present invention; and

FIG. 6 illustrates a flow chart of a method for computing relevancy according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Various example embodiments of the present invention implement an adaptive user interface (UI) that may modify the human-computer interaction based on inferences of user needs. The inferences may be made based on relevancy values determined for various UI items, such as emails, text messages, application icons, widgets, or the like. The relevancy values of the UI items may be determined based on number of components that make up a user's context. In this regard, a context model of the user may be defined with respect to UI items based on components derived from the UI items, themselves, and components derived from the user. In this regard, a user's context model may be determined based on behavioral components derived from the actions of the user, semantic components derived from data stored on the user's electronic device (e.g., mobile terminal), and bio-components of the internal state of the user based on captured physiological data and/or psycho-physiological data. Using these components, various example embodiments may be configured to infer the needs of a user with respect to a UI. The resultant context model provides for inferring the needs of the user based on a probabilistic analysis. In this regard, inferences may be based, for example, on behavioral components such as past actions and semantic components such as parsed portions of content stored in a device. When the UI is adapted based on the inference, the user may react to the adaptation by accepting, rejecting, or partially accepting the recommended UI. Based on a user's response to the adapted UI, additional information may be gathered about the user for use with future inferences.

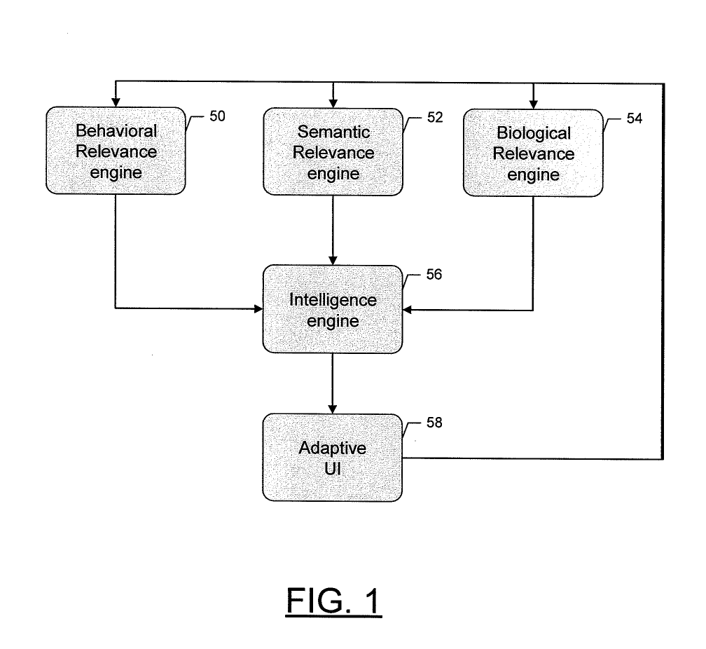

Various example embodiments of the present invention provide for computing a relevancy value with respect to a user interface item to facilitate arranging the user interface for a particular user. The relevancy value may be determined based on a number of factors including a behavioral factor, a semantic factor, and a physiological (or internal state of the user) factor. FIG. 1 depicts an example schematic representation of a system that considers these factors in the computation of a relevancy value to arrange a user interface for a user. The system of FIG. 1 includes a behavioral relevance engine 50 for considering a behavioral factor, a semantic relevance engine 52 for considering a semantic factor, and a biological relevance engine 54 for considering a physiological factor and the internal state of the user. The behavioral relevance engine 50, the semantic relevance engine 52, and the biological relevance engine 54 may feed into an intelligence engine 56 configured to combine the various factors to form an overall relevancy value for a particular item. In turn, based on the overall relevancy value generated by the intelligence engine 56, an adaptive user interface (UI) 58 may be implemented to arrange or organize user interface items based on relevance. According to various example embodiments, the behavioral relevance engine 50, the semantic relevance engine 52, the biological relevance engine 54, the intelligence engine 56, and the adaptive UI 58 may be implemented by a specifically configured hardware processor of an electronic device.

With respect to the determination of a behavioral relevance factor, the actions of the user may be considered, such as, actions indicated by electronically stored task logs, a user's social context (e.g., meeting, social networking presence, and the like), location, and time. The considered actions may be captured by a user's electronic device. For example, an action may be a detection of movement by a user via the implementation of a positioning sensor on the user's electronic device. The actions may also be events planned and stored in the user's electronic calendar. The actions may also be the applications implemented by the user on the electronic device (e.g., web browsing). Additionally, aspects of the actions may also be considered, such as the time and location of the user when, for example, the applications are implemented.

According to various example embodiments, a current behavioral context with respect to a UI item may be used to determine a behavioral factor. For example, if the user is currently located close to the home of a contact in the contact list stored on the user's electronic device, and an appointment with the contact is scheduled in the user's calendar, then the value of the behavioral relevancy factor for the UI item (that is the representation of the contact) may be assigned a high behavioral relevancy factor.

Based on the various behavioral components that may be considered, a behavior model may be constructed for a user and/or UI items for that user. The behavioral components may be modeled using graphical and statistical clustering algorithms. The algorithms may compute relevance values for the behavioral nodes in a connected database or other source of behavioral data. In this regard, the models may be constructed using algorithms such as Linked UI, Self-Organizing Maps (SOM), principal component analysis (PCA), and the like. Via the model, results for the behavioral relevance factor (=behaviour.relevance) may be determined. In some example embodiments, the behavior relevance factor may take the form of a vector and may be combined with the relevance factors computed for the semantic and internal state of the user factors.

As described above, a semantic relevance factor may also be determined. The semantic relevance factor may be determined based on the content of data stored and/or received by the user's electronic device, possibly via the device's communications capabilities. A semantic or content model may be generated via methods such as Natural Language Processing (NLP) and statistical clustering methods (e.g., PCA, SOM, and the like) to parse the content of, for example, text messages, emails, objects in images (e.g., people, locations, products, or the like) and compute a semantic relevance factor (=semantic.relevance). In some example embodiments, semantic tagging of content may be leveraged to assist in computing the semantic relevance factor. Face detection and classification algorithms for classifying individuals identified in the stored images may also be utilized. Additionally, the NLP algorithm may be used to parse the text of emails, text messages, and documents to classify the functional and emotional phrases included therein.

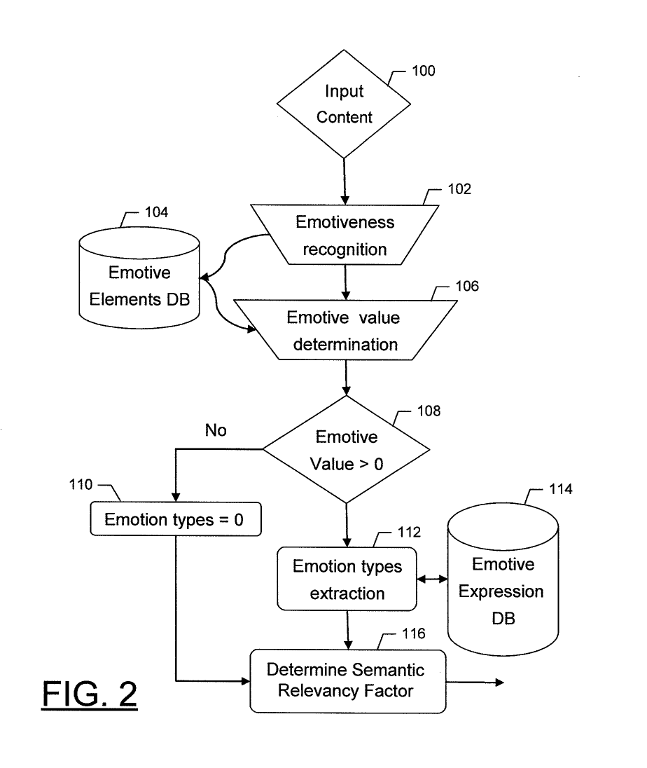

FIG. 2a illustrates a flow chart for determining a semantic relevancy factor according to various example embodiments. In this regard, at 100, input text from an email, text message, document or the like may be considered. At 102, an emotiveness recognition process may be undertaken with respect to the analyzed text. An emotive elements database 104, which indicates values for various textual emotive elements, may be utilized at 106 to determine an emotive value for the analyzed text. At 108, if emotive text is present (e.g., if the emotive value is greater than zero), then the emotion types may be extracted at 112 based on an emotive expression database 114 and the semantic relevancy factor may be determined at 116. If there is no emotive text present, then no emotion types are present in the text (e.g., the emotion types are equal to zero) at 110, and the semantic relevancy factor may be determined accordingly at 116.

Further, a relevance factor may also be determined with respect to the internal state of the user. The relevance factor based on user's internal state may be computed by statistically classifying signals captured from the user's body. Signals captured by an electronic device configured to detect galvanic skin response (GSR), perform electroencephalography (EEG), perform electrocardiography (EKG), perform electromyography (EMG), detect heart rate, detect blood pressure, and the like, may be used to identify physiological components. Through these components, a measure of the arousal (how excited) and valence (positive and negative) state of the user may be determined. The resulting internal state of the user relevance value (=bio.relevance) may indicate the physical and emotional state of the user.

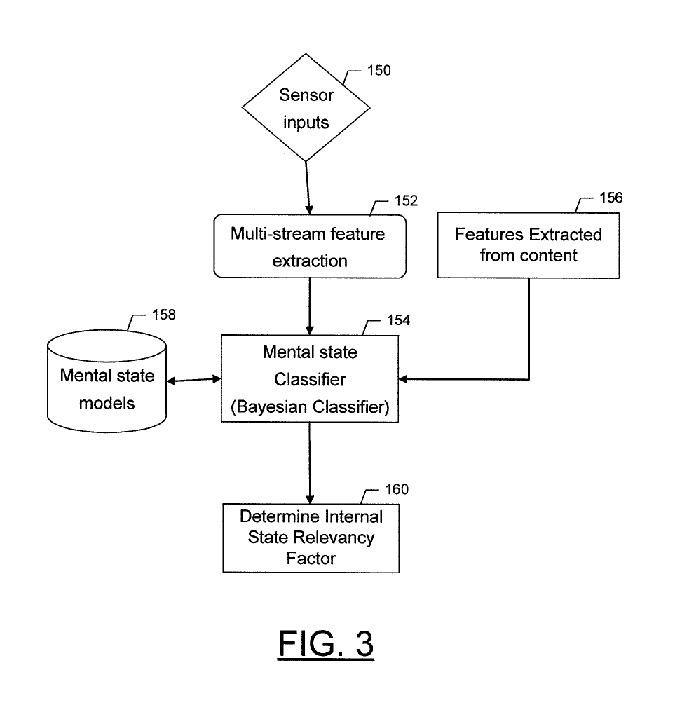

FIG. 3 illustrates a flowchart for determining the internal state of the user in accordance with various example embodiments. At 150, physiological sensors may detect information or signals about the user. At 152, a multi-stream feature extraction may be performed to identify information that may be classified. Once the features are extracted from the sensor signals, the features may be combined with the features extracted from the content at 156 and fed to the mental state classifier, which may be a Bayesian classifier, at 154. To classify the features, mental state models 158 may be used. In this regard, the classifier may be trained offline using data collected from other users over a period of time using simulated situations that may elicit various emotions.

With respect to classifying the emotive features, such as, for example at 154, in relation with physiology, emotions may be described as points in a two dimensional space of affective valence and arousal, in which valence represents overall pleasantness of emotional experiences ranging from negative to positive, while arousal represents the intensity level of emotion, ranging from calm to excited. The simplest differentiation of emotions may be a differentiation between positive and negative emotions. In most cases of human-computer interaction, this differentiation may be sufficient to improve the dialog between user and computer. For example, when a user has a negative emotion, the computer can adapt its dialog to the negative emotion, depending on the context. The valence-arousal model may differentiate between emotions with respect to both valence (positive and negative affect) and arousal (intensity of the emotion), which provides for determining the difference between roughly four categories of emotions, when differentiated between high valence and low valence and high arousal and low arousal.

Additionally, classification may be performed in consideration of other components. For example, features extracted from text at 156, such as text entered by the user, may be considered. Having classified the features, an internal state relevancy factor may be determined at 160.

The behavioral relevancy factor, the semantic relevancy factor, and the internal state of the user relevancy factor may be combined to generate an overall relevancy value for a given UI element. To do so, for each possible outcome (or recommendation), the overall relevance coefficient may be determined according to:

Recommendation.relevance=f(behaviour.relevance, semantic.relevance, bio.relevance)

where “f( )” is a nonlinear function for combining the different relevance factors. According to some example embodiments, each of the relevancy factors may also be weighted by the respective values for alpha, beta, and gamma. The weights alpha, beta, and gamma may be estimated using a training data set to heuristically or statistically learn methods such as regression and linear discriminant analysis for compiling the training data. In some examples, the weightings may be application specific and the weights may be dependent on the type of application. As such,

Recommendation.relevance (i)=alpha*behaviour.relevance(i)+beta* semantic.relevance(i)+gamma*bio.relevance(i)

and,

Probability(Recommendation.relevance(i))=exp(recommendation.relevance(i))/Sum(exp(recommendation.relevance(i)))

Based on the foregoing, an example scenario where a determination of an overall relevancy value can be provided. In this regard, a behavior relevancy factor (e.g., via Linked UI) may be computed based on a list of UI items while John (the user) is away from a device for some time. Once John was available, the UI items may be displayed in the UI based on the decreasing order of behaviour.relevance. Further, consider the situation where an email is received from Mary that John has chosen from the list, and the email included words like “Wow” and “How Cool.” The semantic.relevance computed, for example, by the NLP algorithm may be high for such emotional words. The GSR and heart rate sensors may also indicate high level of excitation resulting in a high bio.relevance value. As a result, the overall relevancy value may increase the relevance of Person:Mary. Accordingly, content and actions associated with Mary may also receive a higher value.

Further, in accordance with the foregoing description, some example embodiments of the present invention provide a framework of a method for computation of relevancy by taking into account all the variables that affect relevancy. The framework may allow relevance value computations for any application in a modular way. As such, relevancy calculations may be utilized within the context of any application that may be executed, for example, on a smart phone, which enables algorithmic design of applications based on efficient use cases.

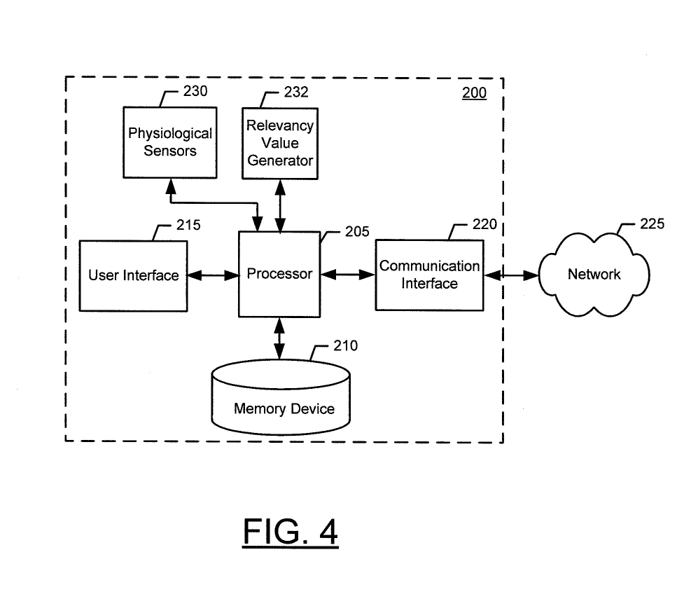

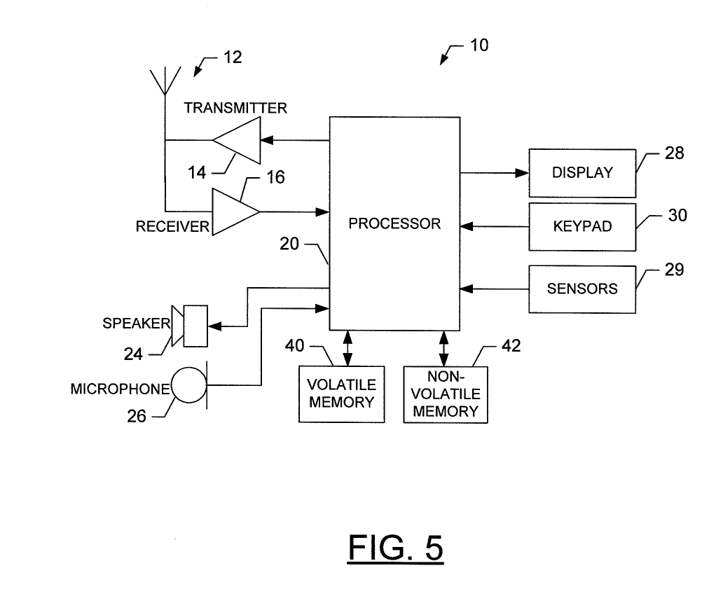

The description provided above and generally herein illustrates example methods, example apparatuses, and example computer program products for computing relevancy. FIGS. 4 and 5 depict example apparatuses that are configured to perform various functionalities as described herein, such as those described with respect to FIGS. 1-3 and 6.

Referring now to FIG. 4, an example embodiment of the present invention is the apparatus 200. Apparatus 200 may, be embodied as, or included as a component of, a communications device with wired or wireless communications capabilities. In some example embodiments, the apparatus 200 may be part of a communications device, such as a stationary or a mobile communications terminal. As a stationary communications terminal, the apparatus 200 may be part of, or embodied as, a server, a computer, an access point (e.g., base station), communications switching device, or the like. As a mobile device, the apparatus 200 may be a mobile and/or wireless communications node such as, for example, a mobile and/or wireless server, computer, access point, communications switching device, handheld device (e.g., telephone, portable digital assistant (PDA), mobile television, gaming device, camera, video recorder, audio/video player, radio, and/or a global positioning system (GPS) device), any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, physiological sensors 230, and a relevancy value generator 232. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a communications server) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 215. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 215 may be any device or means embodied in either hardware, a computer program product, or a combination of hardware and a computer program product that is configured to receive and/or transmit data from/to a network 225 and/or any other device or module in communication with the example apparatus 200. The communications interface may be configured to communicate information via any type of wired or wireless connection, and via any type of communications protocol, such as communications protocol that support cellular communications. Processor 205 may also be configured to facilitate communications via the communications interface by, for example, controlling hardware included within the communications interface 215. In this regard, the communication interface 215 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The physiological sensors 230 may be any type of sensors configured to capture physiological information about a user of the apparatus 200. For example, the physiological sensors 230 may include the hardware and/or software to detect galvanic skin response (GSR), perform electroencephalography (EEG), perform electrocardiography (EKG), perform electromyography (EMG), detect heart rate, detect blood pressure, and the like. The processor 205 may receive indications of physiological data captured by the physiological sensors 230, store the data in the memory device 210, and/or use the data for relevancy computations, such as an internal state of the user relevancy factor determinations.

The relevancy value generator 232 of example apparatus 200 may be any means or device embodied, partially or wholly, in hardware, a computer program product, or a combination of hardware and a computer program product, such as processor 205 implementing stored instructions to configure the example apparatus 200, memory device 210 storing executable program code instructions configured to carry out the functions described herein, or a hardware configured processor 205 that is configured to carry out the functions of the relevancy value generator 232 as described herein. In an example embodiment, the processor 205 includes, or controls, the relevancy value generator 232. The relevancy value generator 232 may be, partially or wholly, embodied as processors similar to, but separate from processor 205. In this regard, the relevancy value generator 232 may be in communication with the processor 205. In various example embodiments, the relevancy value generator 232 may, partially or wholly, reside on differing apparatuses such that some or all of the functionality of the relevancy value generator 232 may be performed by a first apparatus, and the remainder of the functionality of the relevancy value generator 232 may be performed by one or more other apparatuses.

The relevancy value generator 232 may be configured to perform the functionally described with respect to FIGS. 1-3. In this regard, for example, the behavioral relevance engine 50, the semantic relevance engine 52, biological relevance engine 54, intelligence engine 56, and the adaptive UI 58 may be implemented by the relevancy value generator.

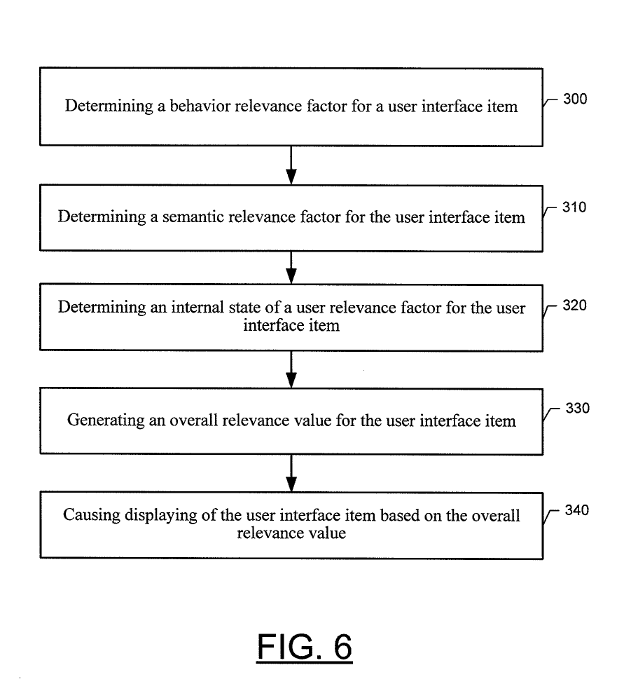

Further, the apparatus 200 and the processor 205 may be configured to perform the following functionality via the relevancy value generator 232. In this regard, the relevancy value generator 232 may be configured to cause the processor 205 and/or the apparatus 200 to perform various functionalities, such as those depicted in the flowchart of FIG. 6 and as generally described herein. In this regard, the relevancy value generator 232 may be configured to determine a behavior relevance factor for a user interface item at 300. According to some example embodiments, determining the behavior relevance factor includes determining the behavior relevance factor based upon user actions or indications of planned actions captured by the apparatus 200. The relevancy value generator 232 may also be configured to determine a semantic relevance factor for the user interface item at 310. According to some example embodiments, determining the semantic relevance factor includes determining the semantic relevance factor based upon data stored on the apparatus 200. Further, the relevancy value generator 232 may also be configured to determine an internal state of a user relevance factor for the user interface item at 320. In some example embodiments, determining the internal state of the user relevance factor includes determining the internal state of the user relevance factor based upon physiological information of the user captured by the apparatus 200.

The relevancy value generator 232 may also be configured to generate an overall relevance value for the user interface item at 330. In this regard, the overall relevance value may be a function of the behavior relevance factor, the semantic relevance factor, and the internal state of the user relevance factor. According to some example embodiments, generating the overall relevance value includes generating the overall relevance value where the overall relevance value is a nonlinear function of the behavior relevance factor, the semantic relevance factor, and the internal state of the user relevance factor. Additionally, or alternatively, according to some example embodiments, generating the overall relevance value includes applying respective weights to the behavior relevance factor, the semantic relevance factor, and the internal state of the user relevance factor. The respective weights may be determined based on a heuristic or statistical analysis of data. In some example embodiments, the relevancy value generator 232 may be further configured to cause displaying of the user interface item based on the overall relevance value.

Referring now to FIG. 5, a more specific example apparatus in accordance with various embodiments of the present invention is provided. The example apparatus of FIG. 5 is a mobile terminal 10 configured to communicate within a wireless network, such as a cellular communications network. The mobile terminal 10 may be configured to perform the functionality of the mobile terminal 101 and/or apparatus 200 as described herein. More specifically, the mobile terminal 10 may be caused to perform the functionality of the relevancy value generator 232 via the processor 20. Processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

Further, the processor 20 may be configured to implement the functionality described herein with respect to FIGS. 1-3, such as the functionality of the behavioral relevance engine 50, the semantic relevance engine 52, biological relevance engine 54, intelligence engine 56, and the adaptive UI 58. The processor 20 may also be configured to perform the example method of FIGS. 6.

The mobile terminal 10 may also include an antenna 12, a transmitter 14, and a receiver 16, which may be included as parts of a communications interface of the mobile terminal 10. The speaker 24, the microphone 26, the display 28 (which may be a touch screen display), and the keypad 30 may be included as parts of a user interface. In some example embodiments, the mobile terminal 10 includes sensors 29, which may include physiological sensors, positioning sensors (e.g., global positioning system (GPS) sensors), and the like. The mobile terminal 10 may also include an image and audio capturing module for capturing photographs and video content.

FIGS. 1-3 and 6 illustrate flowcharts of example systems, methods, and/or computer program products according to example embodiments of the invention. It will be understood that each operation of the flowcharts, and/or combinations of operations in the flowcharts, can be implemented by various means. Means for implementing the operations of the flowcharts, combinations of the operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIGS. 1-3 and 6 may be stored on a memory device, such as memory device 210, volatile memory 40, or volatile memory 42, of an example apparatus, such as example apparatus 200 or mobile terminal 10, and executed by a processor, such as the processor 205 or processor 20. As will be appreciated, any such program code instructions may be loaded onto a computer or other programmable apparatus (e.g., processor 205, memory device 210, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
determining a behavior relevance factor for a user interface item;
determining a semantic relevance factor for the user interface item;
determining an internal state of a user relevance factor for the user interface item; and
generating, via a processor, an overall relevance value for the user interface item, the overall relevance value being a function of the behavior relevance factor, the semantic relevance factor, and the internal state of the user relevance factor.

2. The method of claim 1, further comprising causing displaying of the user interface item based on the overall relevance value.

3. The method of claim 1, wherein determining the behavior relevance factor includes determining the behavior relevance factor based upon user actions or indications of planned actions captured by an electronic device.

4. The method of claim 1, wherein determining the semantic relevance factor includes determining the semantic relevance factor based upon data stored on an electronic device.

5. The method of claim 1, wherein determining the internal state of the user relevance factor includes determining the internal state of the user relevance factor based upon physiological information of the user captured by an electronic device.

6. The method of claim 1, wherein generating the overall relevance value includes generating the overall relevance value, the overall relevance value being a function of the behavior relevance factor, the semantic relevance factor, and the internal state of the user relevance factor, the function being a nonlinear function.

7. The method of claim 1, wherein generating the overall relevance value includes applying respective weights to the behavior relevance factor, the semantic relevance factor, and the internal state of the user relevance factor, the respective weights being determined based on a heuristic analysis of data.

8. An apparatus comprising at least one processor and at least one memory including computer program code, the at least one memory and the computer program code configured to, with the at least one processor, direct the apparatus at least to perform:
determining a behavior relevance factor for a user interface item;
determining a semantic relevance factor for the user interface item;
determining an internal state of a user relevance factor for the user interface item; and
generating an overall relevance value for the user interface item, the overall relevance value being a function of the behavior relevance factor, the semantic relevance factor, and the internal state of the user relevance factor.

9. The apparatus of claim 8, wherein the apparatus is further directed to perform causing displaying of the user interface item based on the overall relevance value.

10. The apparatus of claim 8, wherein the apparatus directed to perform determining the behavior relevance factor includes being directed to perform determining the behavior relevance factor based upon user actions or indications of planned actions captured by an electronic device.

11. The apparatus of claim 8, wherein the apparatus directed to perform determining the semantic relevance factor includes being directed to perform determining the semantic relevance factor based upon data stored on an electronic device.

12. The apparatus of claim 8, wherein the apparatus directed to perform determining the internal state of the user relevance factor includes being directed to perform determining the internal state of the user relevance factor based upon physiological data of the user captured by an electronic device.

13. The apparatus of claim 8, wherein the apparatus directed to perform generating the overall relevance value includes being directed to perform generating the overall relevance value, the overall relevance value being a function of the behavior relevance factor, the semantic relevance factor, and the internal state of the user relevance factor, the function being a nonlinear function.

14. The apparatus of claim 8, wherein the apparatus directed to perform generating the overall relevance value includes being directed to perform applying respective weights to the behavior relevance factor, the semantic relevance factor, and the internal state of the user relevance factor, the respective weights being determined based on a heuristic analysis of data.

15. The apparatus of claim 8, wherein the apparatus is a mobile terminal, and wherein the mobile terminal includes a display driven by the processor.

16. The apparatus of claim 15 further comprising physiological data detection circuitry configured to capture physiological data of the user for use in determining the internal state of the user relevance factor.

17. A computer program product comprising a computer readable storage medium having computer program code stored thereon, the computer program code being configured to, when executed, direct an apparatus to perform:
determining a behavior relevance factor for a user interface item;
determining a semantic relevance factor for the user interface item;
determining an internal state of a user relevance factor for the user interface item; and
generating an overall relevance value for the user interface item, the overall relevance value being a function of the behavior relevance factor, the semantic relevance factor, and the internal state of the user relevance factor.

18. The computer program product of claim 17, wherein the computer program code is configured to direct the apparatus to cause displaying of the user interface item based on the overall relevance value.

19. The computer program product of claim 17, wherein the computer program code configured to direct the apparatus to perform generating the overall relevance value includes being configured to direct the apparatus to perform generating the overall relevance value, the overall relevance value being a function of the behavior relevance factor, the semantic relevance factor, and the internal state of the user relevance factor, the function being a nonlinear function.

20. The computer program product of claim 17, wherein the computer program code configured to direct the apparatus to perform generating the overall relevance value includes being configured to direct the apparatus to perform applying respective weights to the behavior relevance factor, the semantic relevance factor, and the internal state of the user relevance factor, the respective weights being determined based on a heuristic analysis of data.
